(19) United States
(12) Patent Application Publication
(10) Pub. No.: US 2015/0320168 A1
(43) Pub. Date: Nov. 12, 2015

(54) MAGNETIC CASE OR HOLDER FOR SMARTPHONES AND PORTABLE ELECTRONIC DEVICES

(71) Applicant: Dov Hoffman, Bakersfield, CA (US)

(72) Inventor: Dov Hoffman, Bakersfield, CA (US)

(21) Appl. No.: 14/705,799

(22) Filed: May 6, 2015

Related U.S. Application Data
(60) Provisional application No. 61/989,535, filed on May 7, 2014.

(51) Int. Cl. A45C 13/10; A45C 11/00; A45C 13/02; H01F 7/02

(52) U.S. Cl. CPC A45C 13/1069; H01F 7/0252; A45C 11/00; A45C 13/02; A45C 2011/002

(57) ABSTRACT

A magnetic device is provided, which includes an array of magnet stacks placed on a base plate that has a paramagnetic property. Each stack of one or more magnets is arranged such that the opposite poles of adjacent magnets in the stack face each other and preferably are in contact with each other. The magnet stacks form an M×N array; in each row and each column of the array, the magnet stacks have alternating polarities throughout the row or column. The adjacent stacks in the array are preferably in contact with or in close proximity of each other. A case or holder is also disclosed, which have pocket(s) in which the magnetic device(s) is disposed, for carrying mobile phones or other electronic devices or small items.

### BACKGROUND OF THE INVENTION

1. Field of the Invention

This invention is in the field of portable cases and holders. More specifically this invention relates to a case or holder with a magnetic device inside or affixed thereto, for carrying smartphones, portable electronic devices and other personal effects.

2. Description of the Related Art

Personal items, such as, mobile electronic devices, smartphones and keys, are generally carried on one's person (in clothing pockets), in bags or purses, or by means of a clip that is attached to clothing or belts.

Items placed in pant pockets can be uncomfortable when an individual is seated, and therefore are often removed and placed on legs or nearby surfaces, leaving the item less protected. Existing cases can protect the device, but cannot be securely, easily and comfortably attached to the person. With existing cases, the devices are not easily viewable and accessible, from one's person.

Magnets have long been used to hold objects to a surface. In many such devices, due to the magnetic force being weak in the vertical direction, objects attached to a magnet can slip vertically downward if they are too heavy, or if there is too much movement (for example, the movement created from an individual walking or running). Using a stronger magnet may decrease the slipping, however this will make it much more difficult for an individual to remove the object from the magnet. Using stronger magnets may be damaging to the functionality of an electronic device. Magnets used in connection with cases or holders are primarily to keep the cases and holders closed, essentially replacing snaps, buttons or zippers.

### SUMMARY OF THE INVENTION

The invention is directed to a magnetic device inserted in or affixed to a case or holder for use in carrying phones, mobile electronic devices and other personal items.

An object of the present invention is to provide such magnetic device for a case or holder for phones and mobile electronic devices that can be easily worn and transported, and can allow for safe and secure carry, access and removal of the phone or device.

The device includes a metallic plate and an array of stacked magnets specifically arranged in a manner to create a larger vertical force, and a smaller horizontal force. The larger vertical force prevents objects from slipping downward, even if there is a sustained period of light or hard movement of the case. The smaller horizontal force allows for easier removal of personal items from the magnetic device and holder, and does not damage the item. In preferred embodiments of the invention, the magnetic device is inserted into a 2 panel folding case or a single panel case.

To achieve these and other advantages and in accordance with the purpose of the present invention, as embodied and broadly described, the present invention provides a magnetic device which includes: a base plate having a paramagnetic property; and a plurality of stacks of magnets disposed on the base plate, wherein each stack of magnets has one or more magnets, wherein opposite poles of any adjacent magnets in the stack face each other, wherein the plurality of stacks of magnets form an M×N array, at least one of M and N being greater than one, wherein in each row and each column of the array, the magnet stacks have alternating polarities throughout the row or column.

In another aspect, the invention provides a case or holder which includes one or two panels each having a pocket in which the magnetic device is placed.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a perspective view of a magnetic device according to an embodiment of the present invention.

FIG. 2 is a top view of the magnetic device.

FIG. 3 is a side view of the magnetic device.

FIG. 4a is and enlarged side view of a single stack of magnets, showing the polarities of the magnets.

FIG. 4b is a side view of an array of magnets of the magnetic device, showing the polarities of the magnets.

FIG. 5 is a top view of the magnetic device, showing the polarities of the magnets.

FIG. 6. Is a side view of a magnetic device according to another embodiment of the invention.

FIG. 7 is a top view of the interior of a sample case, with a magnetic device inside.

FIG. 8 is a side view of the interior of a sample case with magnetic devices inside.

FIG. 9 is a side view of a sample case with magnetic devices inside.

FIGS. 10A and 10B are depictions of the horizontal and vertical strength of an object carried by a conventional magnetic device and the magnetic device according to an embodiment of the invention, respectively.

### DETAILED DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

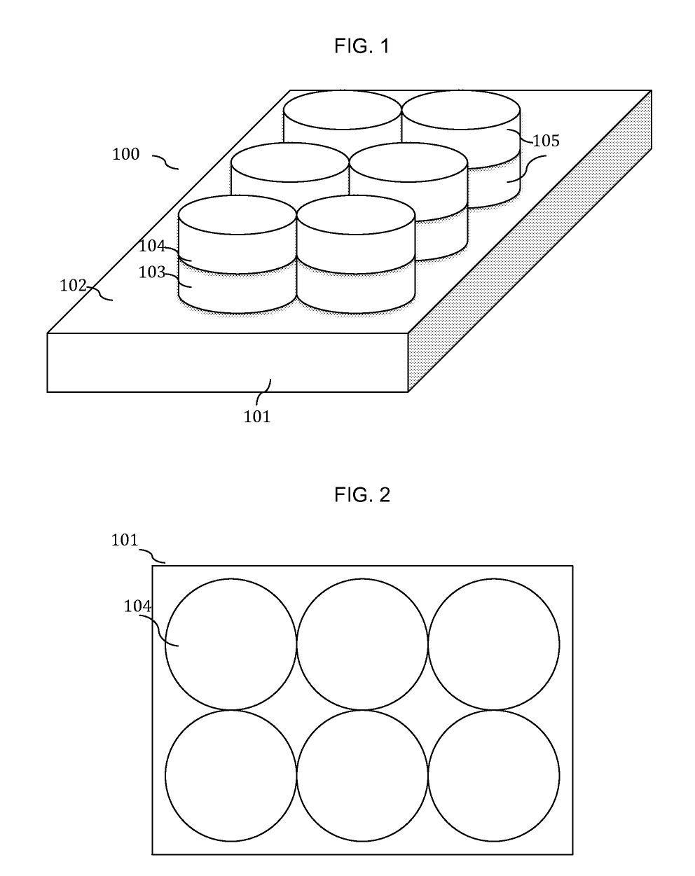

FIG. 1 is a perspective view of a magnetic device 100 according to an embodiment of the present invention. The magnetic device 100 comprises a metallic base plate 101 and an array 102 of stacked disc magnets 105. Each stack includes a bottom magnet 103 and top magnet 104 in contact with each other.

It is appreciated that each stack of magnets is in physical contact with at least some adjacent stacks of magnets. It is further appreciated that the array 102 of magnets do not need to come to the edges of the base plate 101.

The array 102 in the FIG. 1 is a 3×2 array of stacked disc magnets. It is appreciated that the array size can be decreased (but must be greater than a 1×1 array, or a single stack 105) or increased in either dimension depending on the radius of the individual disc magnets and the intended use of the case (that is, the overall size of the personal object(s) to be carried).

In a preferred embodiment and for use in carrying smartphones, such as the iPhone5, and similarly sized mobile electronic devices, a 4×2 array 102 is used, with the metallic base plate 101 having a thickness of in the range of 1/32- 1/16″. The disc magnets in the 4×2 array may be the rare earth magnet Neodynium. In one particular implementation, Neodymium 48 is used on the bottom magnets 103 and Neodymium 45 is used on the top magnets 104. The dimensions of the discs are ¾″ (diameter) by 1/32- 1/16″ (thickness). Other sizes may also be used.

In an alternate embodiment, a smaller 2×2 array 102 can be used to carry personal items, such as keys or small tools.

FIG. 2 is a top view of the magnetic device 100 in one embodiment. The top magnets 104 of the array 102 of stacked magnets 105 are visible. Each stack of magnets is in physical contact with adjacent stacks in the same row and the same column of the array. It is appreciated that the array 102 of magnets can reach the edge of the base plate 101.

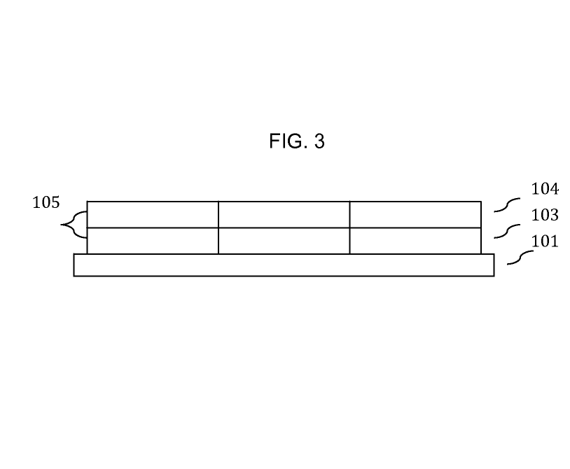

FIG. 3 is a side view of the magnetic device 100 in one embodiment. The base plate 101 is in contact with the bottom magnets 103, which are in turn in contact with the top magnets 104. The back plate 101 is made of a paramagnetic material that is attracted to the magnets 103, e.g., iron or steel. The base plate is preferably a flat plate with no protrusions or recesses on the side where the magnets are located except at the edges. It is appreciated that an adhesive may be used, but is not necessary to further secure the base plate 101 to the bottom magnets 103. In this FIG. 3, the array 102 does reach the edge of the base plate 101. Attaching a magnet to a plate 101 will increase the magnetic surface area of the plate 101.

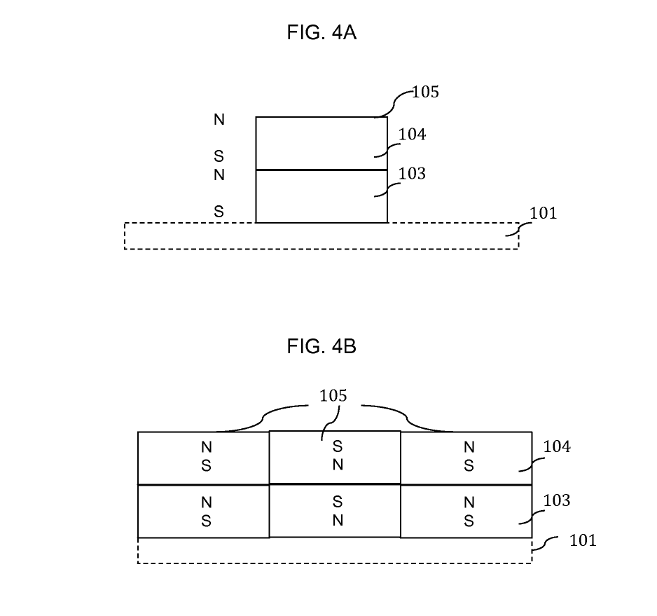

FIG. 4a is an enlarged side view of a single stack of magnets 105, with the magnetic polarity shown. The magnets are stacked such that opposite poles of adjacent magnets are in contact with each other. In FIG. 4, for example, the south pole of top magnet 104 is in contact with the north pole of bottom magnet 103. One or more magnets arranged in the same polarity may be used in each stack in embodiments of the invention. It is appreciated that stacking magnets will makes them stronger, by combining each magnet's individual strength.

FIG. 4b is a side view of the array 102 of stacked magnets 105 (one row of the array is visible). As depicted in FIG. 4b, the stacks of magnets within each row alternate between being North facing up and South facing up.

The magnet stacks 105 continue in this alternating pattern for the length of the array. In other words, no two adjacent stacks have the same polarity. The magnet stacks do not naturally and easily fit together in this alternating manner. A north-facing up magnet stack 105 is able to be placed and fixed in place adjacent to a south-facing magnet stack 105 by first orienting the stacks in the same polarity, bringing the stacks close together such that the stacks are in the same magnetic field, then, while the stacks are in the same magnetic field, turning and flipping one stack such that it orients in the opposite polarity and, with force, placing the stacks in contact with the other stack. This locks the adjacent stacks 105 in place. The force between the stacks 105 becomes greater than the force above or below the magnet stacks 105.

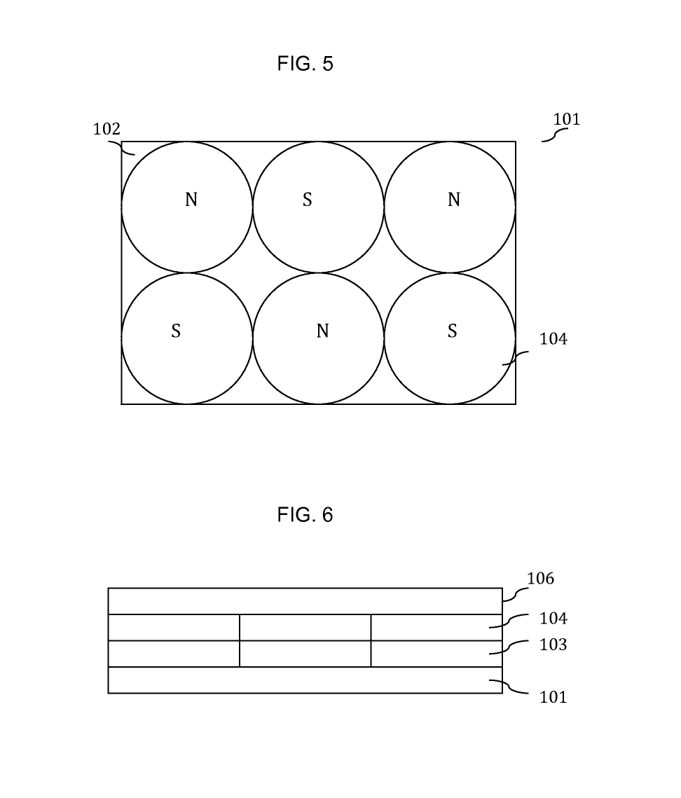

FIG. 5 is a top view showing the polarities of the magnets in the array. FIG. 5 depicts a 3×2 array 102. The top magnets 104 are visible. The orientation of North or South proceeds in an alternating fashion throughout each column and each row of the array, with North-facing up magnet stacks 105 being adjacent to south facing up magnet stacks.

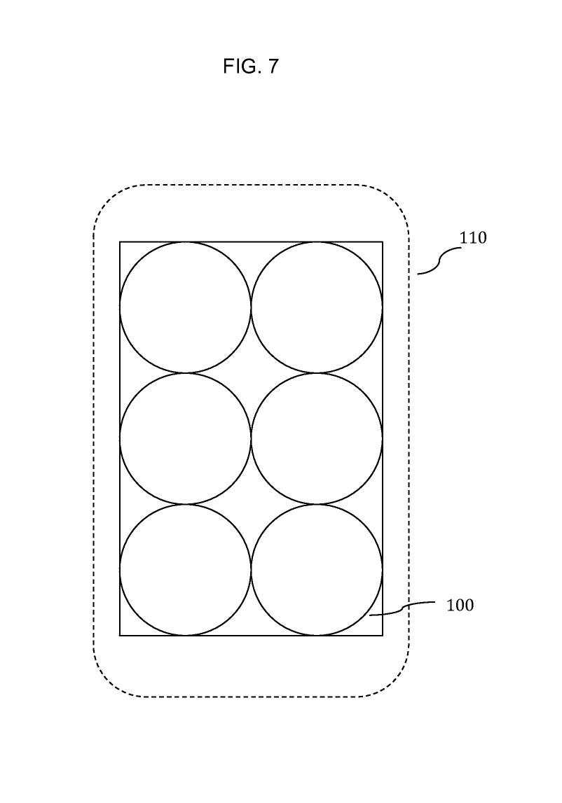

FIG. 6 shows a side view of a magnetic device according to another embodiment of the present invention. In addition to the baseplate 101, bottom magnets 103 and top magnets 104, there is an upper plate 106 parallel to the base plate. The upper plate 106 is not needed for the magnetic functionality of the device, but can aid in insertion into cases and create an additional surface area plate. The upper plate may be made of a paramagnetic material. When magnets are placed in between two paramagnetic plates, the strength or pull force of the magnet increases significantly.

FIG. 7 is a top view of the interior of a sample case 110, with the magnetic device 100 inserted inside. The magnetic device 100 is not visible when viewing the case 110. The magnetic device 100 can be inserted into an existing pocket within a case. Alternatively a case 110 can be built or sewn around the magnetic device 100. Alternatively, an existing case can be retrofitted, whereby the magnetic device 100 can be placed inside. In another embodiment of the invention, the case 110 can have concave finger inserts to allow for easier removal of an object from the case 110.

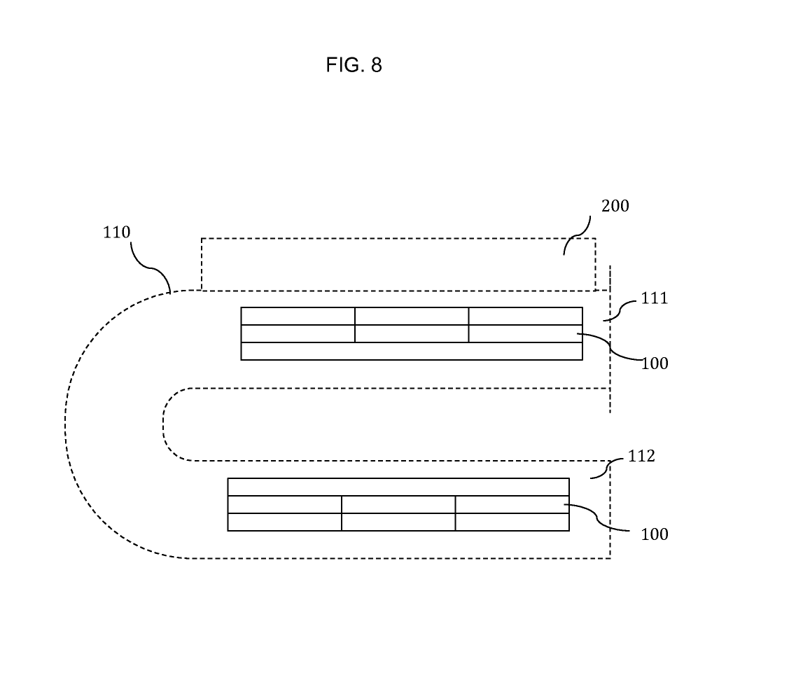

FIG. 8 is a side view of the interior of a sample case 110, placed horizontally, with a first and second magnetic device 100 inserted inside. The magnetic devices 100 cannot be seen from the outside of the case 110. The case 110 consists of a first panel 111 and second panel 112 which are joined together with a flexible joint so that they can be folded to layer on top of one another or straightened out to lay flat. A device 200, such as a smart phone or other mobile electronic device can be placed on either or both of the first panel 111 and second panel 112. The magnetic device 100 in panel 111 and the magnetic device in panel 112 will allow and cause one panel to contact or come into close proximity with the other panel. The size of the device 200 can be smaller or larger than the size of the panel 111. A thin magnetic or paramagnetic adhesive may be placed on any such devices 200 that are not metallic. The placement of the device 200 effectively creates and functions as a second magnetic plate on the array 102.

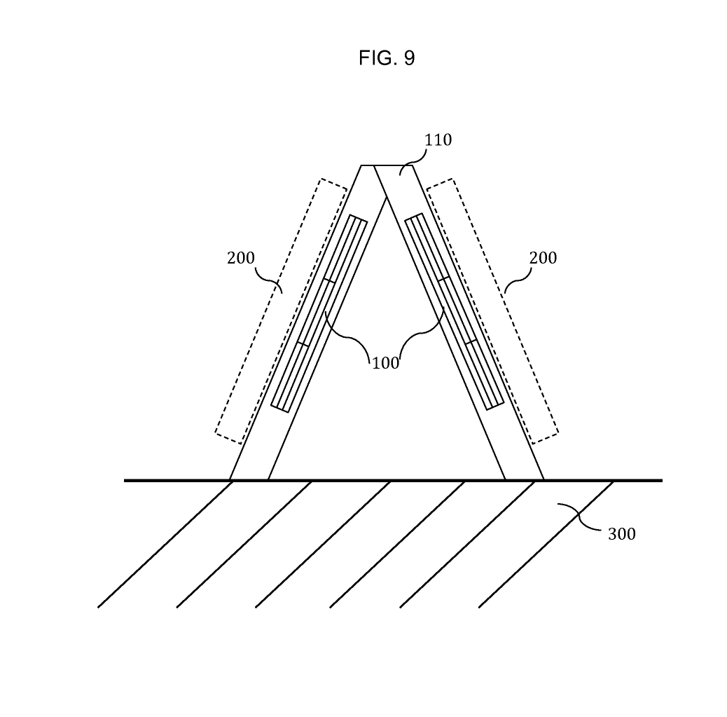

FIG. 9 is a side view of the case 110, place vertically on a surface 300 in an “A” shape, with magnetic devices 100 inside, and a device 200 placed on either side. The case 110 can stand vertically on a desk or table, with a device 200 placed on either or both sides. The case 110 can also be placed vertically in one's pockets, belts or existing bag, suitcase, or purse straps.

In alternative embodiments, additional slits and pockets can be made into the case 110 for carrying business cards and other smaller, non-metallic personal items. In an alternative embodiment of the invention, 2 or more cases 101 can be worn vertically to create and function as a toolbelt, to carry metallic tools of various sizes.

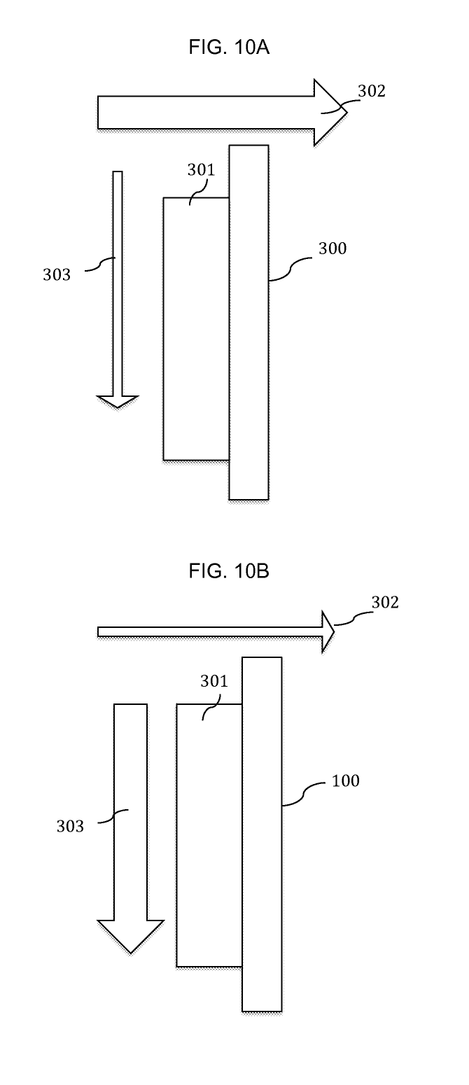

FIGS. 10A and 10B are depictions of the horizontal magnetic strength 302 and vertical magnetic strength 303 of an object 301 placed on a conventional magnet 300 and the magnetic device 100 of an embodiment of the present invention, respectively. In FIG. 10A, the horizontal strength 302, or force of the magnet in the x-direction i.e. the south to north or north to south direction of the magnets, is large. However, the vertical strength 303, or force in the y-direction perpendicular to the x-direction, is small. Therefore, an object 301, is susceptible to vertical slip (in the y-direction). In addition, it is more difficult for one to remove the object 301 from the magnet 300. By preparing and specially placing the stacked magnets 105 in the orientations depicted in FIGS. 5a and 5b, the vertical strength 303 increases and the horizontal strength 302 decreases. In FIG. 10B, the horizontal strength 302, or force of the magnet device 100 in the x-direction, is smaller. The vertical strength 303, or force in the y-direction, is larger. Therefore, an object is less susceptible to slipping downward (in the y-direction). In addition, it is easier for one to remove an object 301 from magnet device 100.

Here, the horizontal and vertical directions refer to such directions when the magnetic device is used to carry the object in the intended manner. The interface where the object and the magnetic device contact each other or are in close proximity (e.g. with a layer of the case or holder 110 sandwiched in between) extends in a direction perpendicular to the north to south or south to north direction of the magnets. This interface is substantially vertical when the object is carried by the case or holder (with the magnetic device inside) in normal use, and the north to south or south to north direction of the magnets is substantially horizontal.

To summarize, the magnetic device according to embodiments of the present invention has the following characteristics: An array of magnet stacks are placed on a base plate that has a paramagnetic property. In the side view (e.g. FIG. 4B), each stack of magnets is arranged such that the opposite poles of adjacent magnets in the stack face each other and preferably are in contact with each other (or they can be in close proximity with each other with a layer of non-magnetic or paramagnetic material sandwiched between two magnets). Each stack can have one or more magnets. In the top view (e.g. FIG. 5), the magnet stacks form an M×N array; in each row and each column of the array, the magnet stacks have alternating polarities throughout the row or column, i.e., any two adjacent stacks in a row or column always have the opposite polarities and no two stacks of the same polarity are adjacent to each other. At least one of M and N is greater than one. The adjacent stacks in each column or row of the array are preferably in contact with or in close proximity of each other.

It will be apparent to those skilled in the art that various modification and variations can be made in the magnetic device of the present invention without departing from the spirit or scope of the invention. Thus, it is intended that the present invention cover modifications and variations that come within the scope of the appended claims and their equivalents.

What is claimed is:

1. A magnetic device comprising:
a base plate having a paramagnetic property; and
a plurality of stacks of magnets disposed on the base plate,
wherein each stack of magnets has one or more magnets, wherein opposite poles of any adjacent magnets in the stack face each other,
wherein the plurality of stacks of magnets form an M×N array, at least one of M and N being greater than one,
wherein in each row and each column of the array, the magnet stacks have alternating polarities throughout the row or column.

2. The magnetic device of claim 1, wherein each stack of magnets includes two or more magnets, and wherein opposite poles of adjacent magnets are in contact with each other.

3. The magnetic device of claim 1, wherein adjacent stacks in each column or row of the array are in contact with each other.

4. The magnetic device of claim 1, wherein each magnet has a disk shape.

5. The magnetic device of claim 4, wherein each magnet is about ¾″ in diameter and 1/32- 1/16″ in thickness.

6. The magnetic device of claim 1, wherein the magnets are made of neodynium.

7. The magnetic device of claim 1, wherein each stack of magnets includes two magnets, including a first magnet made of neodymium 48 disposed on the base plate and a second magnet made of neodymium 45 disposed on top of the first magnet.

8. The magnetic device of claim 1, wherein the base plate is made of metal.

9. The magnetic device of claim 1, further comprising an upper plate, disposed in parallel with the base plate with the stacks of magnets between the base plate and the upper plate.

10. The magnetic device of claim 9, wherein the upper plate is made of metal.

11. A case or holder comprising the magnetic device of claim 1, further comprising a pocket in which the magnetic device is disposed.

12. A case or holder comprising two magnetic devices of claim 1, further comprising:
a first panel having a pocket in which one of the two magnetic devices is disposed; and
a second panel having a pocket in which another one of the two magnetic devices is disposed,
wherein the first and second panels are joined together with a flexible joint.
